(19) United States
(12) Patent Application Publication
(10) Pub. No.: US 2024/0272947 A1
(43) Pub. Date: Aug. 15, 2024

(54) REQUEST PROCESSING TECHNIQUES FOR CONTAINER-BASED ARCHITECTURES

(71) Applicant: Dell Products L.P., Round Rock, TX (US)

(72) Inventors: Ravi Kumar, Taunton, MA (US); Shibi Panikkar, Bangalore (IN)

(21) Appl. No.: 18/110,199

(22) Filed: Feb. 15, 2023

(51) Int. Cl. G06F 9/50

(52) U.S. Cl. CPC G06F 9/5027

(57) ABSTRACT

Methods, apparatus, and processor-readable storage media for request processing techniques for container-based architectures are provided herein. An example method includes obtaining one or more threshold values for each of a plurality of nodes in at least one cluster of a container-based computing environment, wherein the one or more threshold values are configured for one or more corresponding resource types; obtaining resource consumption data for each of the plurality of nodes; determining, based at least in part on the one or more obtained threshold values and the obtained resource consumption data, a set of available nodes from among the plurality of nodes for processing incoming requests to the container-based computing environment; and initiating a routing of the incoming requests to one or more nodes in the set of available nodes.

### FIELD

The field relates generally to information processing systems, and more particularly to processing requests in such systems.

### BACKGROUND

Information processing systems increasingly utilize reconfigurable virtual resources to meet changing user needs in an efficient, flexible, and cost-effective manner. For example, cloud-based computing and storage systems implemented using virtual resources in the form of containers have been widely adopted.

### SUMMARY

Illustrative embodiments of the disclosure provide request processing techniques for container-based architectures. An exemplary computer-implemented method includes obtaining one or more threshold values for each of a plurality of nodes in at least one cluster of a container-based computing environment, wherein the one or more threshold values are configured for one or more corresponding resource types; obtaining resource consumption data for each of the plurality of nodes; determining, based at least in part on the one or more obtained threshold values and the obtained resource consumption data, a set of available nodes from among the plurality of nodes for processing incoming requests to the container-based computing environment; and initiating a routing of the incoming requests to one or more nodes in the set of available nodes.

Illustrative embodiments can provide significant advantages relative to conventional request processing techniques. For example, technical problems associated with node failures resulting from conventional load balancing techniques are mitigated in one or more embodiments by routing incoming requests based at least in part on node and/or pod resource consumption information.

These and other illustrative embodiments described herein include, without limitation, methods, apparatus, systems, and computer program products comprising processor-readable storage media.

### BRIEF DESCRIPTION OF THE DRAWINGS

FIG. 1 illustrates a pod-based container environment within which one or more illustrative embodiments can be implemented.

FIG. 2 illustrates host devices and a storage system within which one or more illustrative embodiments can be implemented.

FIG. 3 illustrates a system architecture including a global workload manager in an illustrative embodiment.

FIG. 4 illustrates a load balancing process in an illustrative embodiment.

FIG. 5 shows a first table including data collected from nodes and a second table that tracks which nodes can be routed incoming requests in an illustrative embodiment.

FIG. 6 shows a flow diagram of a load balancing process for container-based architectures in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

As the term is illustratively used herein, a container may be considered lightweight, stand-alone, executable software code that includes elements needed to run the software code. A container-based structure has many advantages including, but not limited to, isolating the software code from its surroundings, and helping reduce conflicts between different tenants or users running different software code on the same underlying infrastructure. The term “user” herein is intended to be broadly construed so as to encompass numerous arrangements of human, hardware, software or firmware entities, as well as combinations of such entities.

In illustrative embodiments, containers may be implemented using a container-based orchestration system, such as a Kubernetes container orchestration system. Kubernetes is an open-source system for automating application deployment, scaling, and management within a container-based information processing system comprised of components referred to as pods, nodes, and clusters. In at least some embodiments, horizontal scaling techniques increase a number of pods as a load (e.g., a number of requests) increases, while vertical scaling techniques assign more resources to existing pods as the load increases.

Types of containers that may be implemented or otherwise adapted within a Kubernetes system include, but are not limited to, Docker containers or other types of Linux containers (LXCs) or Windows containers. Kubernetes has become a prevalent container orchestration system for managing containerized workloads. It is rapidly being adopted by many enterprise-based information technology (IT) organizations to deploy their application programs (applications). By way of example only, such applications may include stateless (or inherently redundant applications) and/or stateful applications. Non-limiting examples of stateful applications may include legacy databases such as Oracle, MySQL, and PostgreSQL, as well as other stateful applications that are not inherently redundant. While the Kubernetes container orchestration system is used to illustrate various embodiments, it is to be understood that alternative container orchestration systems can be utilized.

Generally, for a Kubernetes environment, one or more containers are part of a pod. Thus, the environment may be referred to, more generally, as a pod-based system, a pod-based container system, a pod-based container orchestration system, a pod-based container management system, or the like. Furthermore, a pod is typically considered the smallest execution unit in the Kubernetes container orchestration environment. A pod encapsulates one or more containers, and one or more pods can be executed on a worker node. Multiple worker nodes form a cluster. A Kubernetes cluster is managed by at least one manager node. A Kubernetes environment may include multiple clusters respectively managed by multiple manager nodes. Furthermore, pods typically represent the respective processes running on a cluster. A pod may be configured as a single process wherein one or more containers execute one or more functions that operate together to implement the process. Pods may each have a unique Internet Protocol (IP) address enabling pods to communicate with one another, and for other system components to communicate with each pod. Also, pods may each have persistent storage volumes associated therewith. Configuration information (e.g., configuration objects) indicating how a container executes can be specified for each pod.

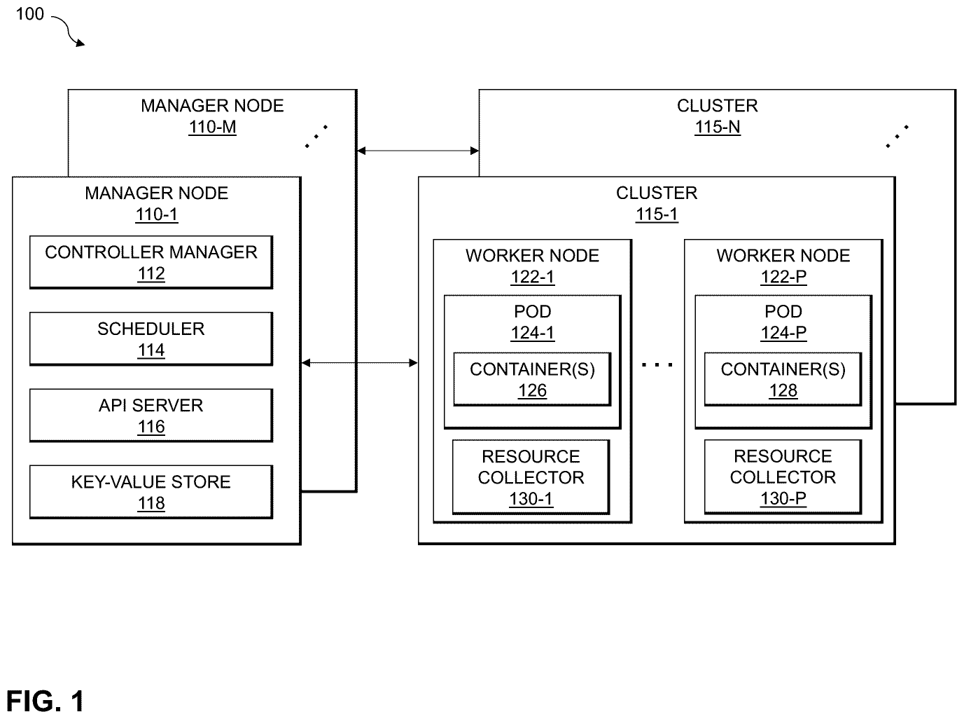

FIG. 1 depicts an example of a pod-based container orchestration environment 100 in an illustrative embodiment. In the example shown in FIG. 1, a plurality of manager nodes 110-1, . . . 110-M (herein each individually referred to as a manager node 110 or collectively as manager nodes 110) are operatively coupled to a plurality of clusters 115-1, . . . 115-N (herein each individually referred to as a cluster 115 or collectively as clusters 115). As mentioned above, each cluster 115 is managed by at least one manager node 110.

Each cluster 115 comprises a plurality of worker nodes 122-1, . . . 122-P (herein each individually referred to as a worker node 122 or collectively as worker nodes 122). Each worker node 122 comprises a respective pod, i.e., one of a plurality of pods 124-1, . . . 124-P (herein each individually referred to as a pod 124 or collectively as pods 124), and a respective resource collector, i.e., one of the plurality of resource collectors 130-1, . . . 130-P (herein each individually referred to as a resource collector 130 or collectively as resource collectors 130). However, it is to be understood that one or more worker nodes 122 can run multiple pods 124 at a time. Each pod 124 comprises a set of containers (e.g., containers 126 and 128). It is noted that each pod 124 may also have a different number of containers. As used herein, a pod may be referred to more generally as a containerized workload. As also shown in FIG. 1, each manager node 110 comprises a controller manager 112, a scheduler 114, an application programming interface (API) server 116, and a key-value store 118. It is to be appreciated that in some embodiments, multiple manager nodes 110 may share one or more of the same controller manager 112, scheduler 114, API server 116, and a key-value store 118. Each resource collector 130 is configured to collect information (e.g., pertaining to resource utilization) related to its corresponding worker node 122, as explained in more detail elsewhere herein.

Worker nodes 122 of each cluster 115 execute one or more applications associated with pods 124 (containerized workloads). Each manager node 110 manages the worker nodes 122, and therefore pods 124 and containers, in its corresponding cluster 115 based at least in part on the information collected by its resource collectors 130. More particularly, each manager node 110 controls operations in its corresponding cluster 115 utilizing the above-mentioned components, e.g., controller manager 112, scheduler 114, API server 116, and key-value store 118, based at least in part on the information collected by the resource collectors 130. In general, controller manager 112 executes control processes (e.g., controllers) that are used to manage operations, for example, in the worker nodes 122. Scheduler 114 typically schedules pods to run on particular worker nodes 122 taking into account node resources and application execution requirements such as, but not limited to, deadlines. In general, in a Kubernetes implementation, API server 116 exposes the Kubernetes API, which is the front end of the Kubernetes container orchestration system. Key-value store 118 typically provides key-value storage for all cluster data including, but not limited to, configuration data objects generated, modified, deleted, and otherwise managed, during the course of system operations.

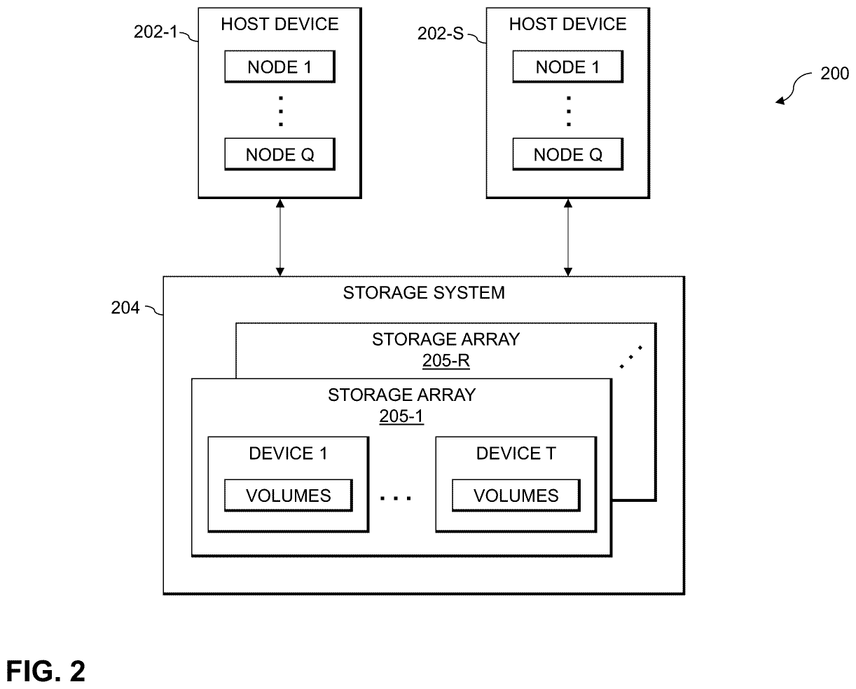

Turning now to FIG. 2, an information processing system 200 is depicted within which the pod-based container orchestration environment 100 of FIG. 1 can be implemented. More particularly, as shown in FIG. 2, a plurality of host devices 202-1, . . . 202-S (herein each individually referred to as a host device 202 or collectively as host devices 202) are operatively coupled to a storage system 204. Each host device 202 hosts a set of nodes 1, . . . Q. Note that while multiple nodes are illustrated on each host device 202, a host device 202 can host a single node, and one or more host devices 202 can host a different number of nodes as compared with one or more other host devices 202.

As further shown in FIG. 2, storage system 204 comprises a plurality of storage arrays 205-1, . . . 205-R (herein each individually referred to as a storage array 205 or collectively as storage arrays 205), each of which is comprised of a set of storage devices 1, . . . T upon which one or more storage volumes are persisted. The storage volumes depicted in the storage devices of each storage array 205 can include any data generated in the information processing system 200 but, more typically, include data generated, manipulated, or otherwise accessed, during the execution of one or more applications in the nodes of host devices 202. One or more storage arrays 205 may comprise a different number of storage devices as compared with one or more other storage arrays 205.

Furthermore, any one of nodes 1, . . . Q on a given host device 202 can be a manager node 110 or a worker node 122 (FIG. 1). In some embodiments, a node can be configured as a manager node for one execution environment and as a worker node for another execution environment. Thus, the components of pod-based container orchestration environment 100 in FIG. 1 can be implemented on one or more of host devices 202, such that data associated with pods 124 (FIG. 1) running on the nodes 1, . . . Q is stored as persistent storage volumes in one or more of the storage devices 1, . . . T of one or more of storage arrays 205.

Host devices 202 and storage system 204 of information processing system 200 are assumed to be implemented using at least one processing platform comprising one or more processing devices each having a processor coupled to a memory. Such processing devices can illustratively include particular arrangements of compute, storage, and network resources. In some alternative embodiments, one or more host devices 202 and storage system 204 can be implemented on respective distinct processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of information processing system 200 are possible, in which certain components of the system reside in one data center in a first geographic location while other components of the system reside in one or more other data centers in one or more other geographic locations that are potentially remote from the first geographic location. Thus, it is possible in some implementations of information processing system 200 for portions or components thereof to reside in different data centers. Numerous other distributed implementations of information processing system 200 are possible. Accordingly, the constituent parts of information processing system 200 can also be implemented in a distributed manner across multiple computing platforms.

Additional examples of processing platforms utilized to implement containers, container environments, and container management systems in illustrative embodiments, such as those depicted in FIGS. 1 and 2, will be described in more detail below in conjunction with additional figures.

It is to be appreciated that these and other features of illustrative embodiments are presented by way of example only, and should not be construed as limiting in any way.

Accordingly, different numbers, types and arrangements of system components can be used in other embodiments. Although FIG. 2 shows an arrangement wherein host devices 202 are coupled to just one plurality of storage arrays 205, in other embodiments, host devices 202 may be coupled to and configured for operation with storage arrays across multiple storage systems similar to storage system 204. The functionality associated with the elements 112, 114, 116, and/or 118 in other embodiments can also be combined into a single module, or separated across a larger number of modules. As another example, multiple distinct processors can be used to implement different ones of the elements 112, 114, 116, and/or 118 or portions thereof.

At least portions of elements 112, 114, 116, and/or 118 may be implemented at least in part in the form of software that is stored in memory and executed by a processor.

It should be understood that the particular sets of components implemented in information processing system 200 as illustrated in FIG. 2 are presented by way of example only. In other embodiments, only subsets of these components, or additional or alternative sets of components, may be used, and such components may exhibit alternative functionality and configurations. Additional examples of systems implementing pod-based container management functionality will be described below.

Still further, information processing system 200 may be part of a public cloud infrastructure. The cloud infrastructure may also include one or more private clouds and/or one or more hybrid clouds (e.g., a hybrid cloud is a combination of one or more private clouds and one or more public clouds).

A Kubernetes pod may be referred to more generally herein as a containerized workload. One example of a containerized workload is an application program configured to provide a microservice. A microservice architecture is a software approach wherein a single application is composed of a plurality of loosely-coupled and independently-deployable smaller components or services.

Container-based microservice architectures have changed the way development and operations teams test and deploy modern software. Containers help companies modernize by making it easier to scale and deploy applications. The pod brings the containers together and makes it easier to scale and deploy applications. Kubernetes clusters allow containers to run across multiple machines and environments: such as virtual, physical, cloud-based, and on-premises environments. As shown and described above in the context of FIG. 1, Kubernetes clusters are generally comprised of one manager (master) node and one or more worker nodes. These nodes can be physical computers or virtual machines (VMs), depending on the cluster. Typically, a given cluster is allocated a fixed number of resources (e.g., CPU, memory, and/or other computer resources), and when a container is defined the number of resources from among the resources allocated to the cluster is specified. When the container starts executing, pods are created on the deployed container that will serve the incoming requests.

Kubernetes clusters, pods, and containers have also introduced new technical problems as pods/containers are scaled within a cluster using a horizontal pod autoscaling (HPA) process, wherein the pod/containers are replicated within the cluster. The HPA process increases the number of pods as the load (e.g., number of requests) increases. Although the HPA process is generally helpful for synchronous and less CPU and memory consuming microservices, container-based platforms are also used for long running workloads, which can be CPU and/or memory intensive. There can be highly critical workloads that cannot afford to fail.

More specifically, Kubernetes enables a multi-cluster environment by sharing and abstracting the underlying compute, network, and storage physical infrastructure, for example, as illustrated and described above in the context of FIG. 2. With shared compute/storage/network resources, the nodes are enabled and added to the Kubernetes cluster. The pod network allows identification of the pod across the network with PodIPs. With this cluster, a pod can run in any node and scale based on a replica set.

Typically, every pod in a cluster is assigned a unique cluster-wide IP address. In such situations, there is no need to explicitly create links between pods as mapping container ports to host ports is seldom needed. This creates a clean, backward-compatible model where pods can be treated similar to VMs or physical hosts from the perspectives of port allocation, naming, service discovery, and load balancing.

The term “ingress” in the context of Kubernetes, refers to an object that defines routing rules for managing access of users to services in a cluster. An ingress controller refers to an application, which typically runs in a cluster and configures a load balancer according to the ingress object. The load balancer can be, for example, a software load balancer running in the cluster, or possibly a hardware or cloud load balancer running outside the cluster. Nginx ingress controller is one example of an ingress controller, which is typically deployed in a pod along with the load balancer. Such load balancers can effectively balance loads within a given node using dynamically generated pods.

Management of pods across multiple clusters is often more challenging. More specifically, each node port manages the pods inside a given node; however, the load balancer is generally kept outside the nodes in a multi-node, multi-cluster environment. In these situations, the load balancer does not have knowledge of the HPA process (as it occurs within the node), or the number of pods created within a cluster. This generally constrains the load balancer to perform a round robin or ratio-based routing algorithm.

By way of example, if a first node has ten pods and another node has twenty pods and a round-robin algorithm is applied, traffic is still distributed equally between the two nodes (assuming a round-robin algorithm is applied). Accordingly, round-robin and ratio-based algorithms can lead to traffic being distributed unequally at the pod level, which in some instances can cause node failure if the pods in a given node reach the maximum allocated resource. It is also noted that each cluster and each node can be configured with different capacities (e.g., the first node in the example above may configured with a capacity of 4 gigabytes (GB), and the second node may be configured with a capacity of 2 GB).

Some conventional techniques provide external load balancing for multi-cluster and/or multi-cloud environments. Such techniques generally require round-robin load balancing, region-based load balancing, or perform cluster load balancing based on ping response times. For each of these techniques, the load balancer distributes the traffic load without knowing whether or not a node in a given cluster can fulfill it. This can result in node failure if additional pods are generated in the node.

At least some illustrative embodiments provide a global workload manager for container-based architectures. Some embodiments described herein can periodically collect information pertaining to incoming requests, resource states, and the number of pods in each node in a cluster. In at least one embodiment, a user can configure a threshold number of resources that can be used in each node. Also, in some embodiments, identify the number of pods that can be horizontally scaled (e.g., by the HPA process) for a given node without overloading that node. For example, the number of pods that can be horizontally scaled can be based at least in part on a corresponding node capacity. This information can be made available to an external load balancer. In some embodiments, the external load balancer can route incoming requests based on such information or queue incoming requests (e.g., if the information indicates that all nodes have reached the maximum allocated resources).

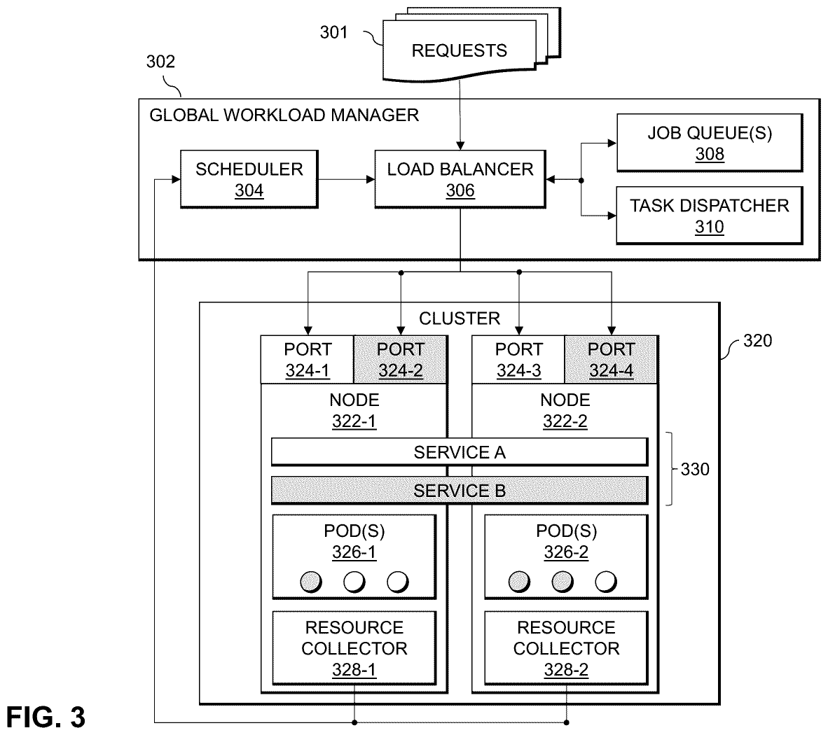

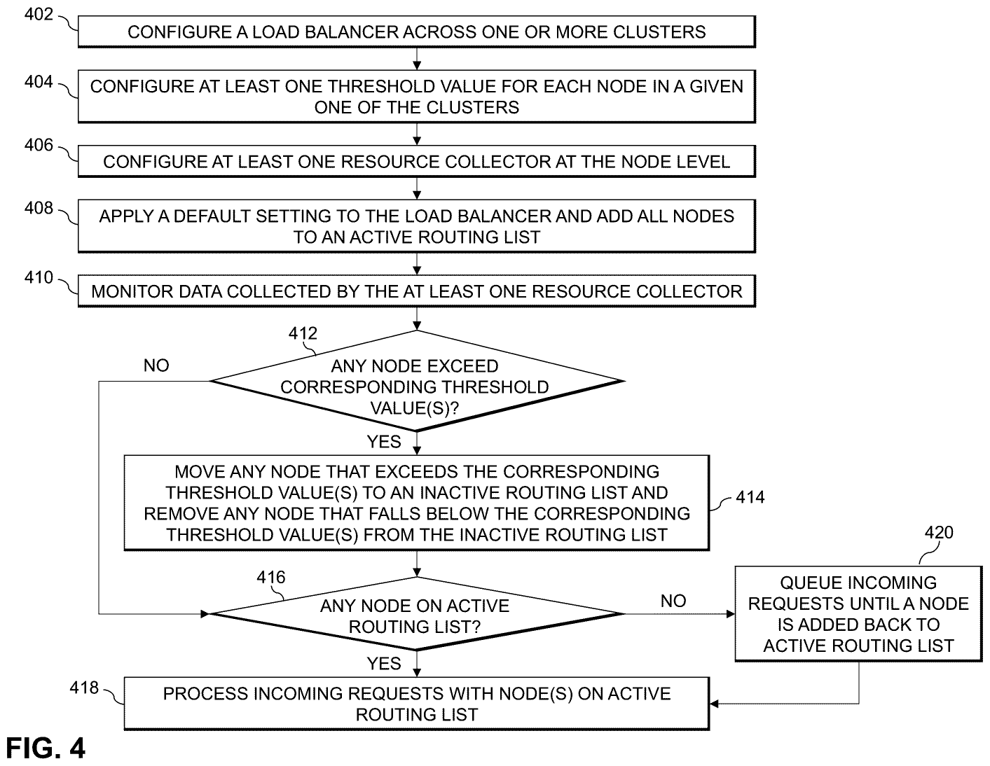

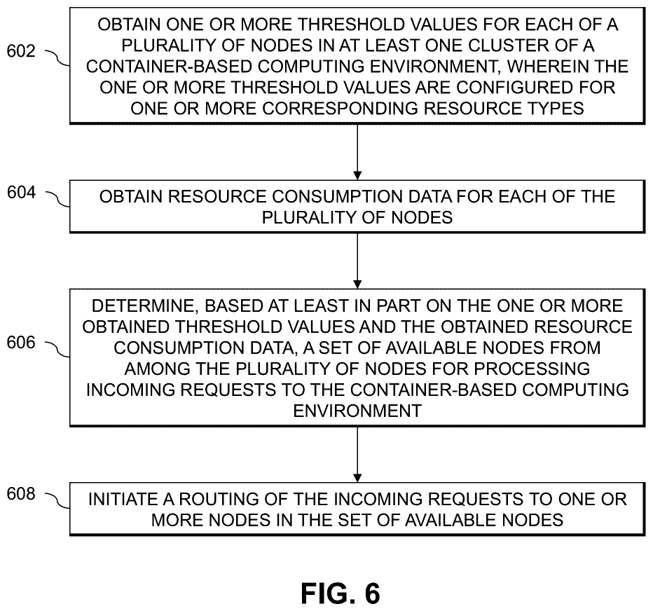

FIG. 3 illustrates a system architecture including a global workload manager in an illustrative embodiment. More particularly, the system architecture comprises a plurality of modules, illustratively interconnected as shown, that are configured to, inter alia, implement a process for globally managing workloads. An example of such a process is described in more detail in conjunction with FIGS. 4 and 6. In some embodiments, the system architecture can correspond to the pod-based container orchestration environment 100 as shown in FIG. 1, for example.

The architecture includes a global workload manager 302 and a cluster 320, which in some embodiments comprises a Kubernetes cluster. In the FIG. 3 example, the global workload manager 302 includes a scheduler 304, a load balancer 306, one or more job queues 308, and a task dispatcher 310; however, it is to be appreciated that in other embodiments, one or more of the elements 304, 306, 308, and 310 (or portions thereof) can be implemented on two or more systems or modules. Also, although only one cluster 320 is shown, it is to be appreciated that embodiments are also applicable to architectures with multiple clusters.

The cluster 320 includes two nodes 322-1 and 322-2 (collectively referred to as nodes 322). Each of the nodes 322 includes a respective set of one or more pods 326-1 and 326-2 and a respective resource collector 328-1 and 328-2 (collectively resource collectors 328). In this non-limiting example, each set of pods 326-1 and 326-2 includes three pods as indicated by the circles in FIG. 3.

Each of the nodes 322 also includes a pair of ports, namely, node 322-1 includes ports 324-1 and 324-2, and node 322-2 includes ports 324-3 and 324-4. The ports 324-1 to 324-4 are used to expose a set of services 330. More specifically, ports 324-1 and 324-3 are used to expose service A, and ports 324-2 and 324-4 are used to expose service B. In this context, the term “service” generally refers to a resource that provides a single point of access from outside a cluster, and allows a group of pods (e.g., replica pods) to be dynamically accessed. It is noted that the elements with darker shading in FIG. 3 correspond to service B.

Generally, the global workload manager 302 is configured to manage how requests 301, from one or more users, are routed. More specifically, the load balancer 306 can initially apply a default load balancing algorithm (e.g., a round robin algorithm) to route the requests 301. For example, the requests 301 can be routed based on respective IP addresses assigned to the nodes 322.

The resource collectors 328 collect information pertaining to the number of requests to the corresponding nodes 322 and the number of current pods implemented at each of the nodes 322. This information can be periodically collected and sent to the scheduler 304. In some embodiments, each of the resource collectors can be implemented as a sidecar application (also referred to herein as an auxiliary application) to the service or at the node-level ingress.

The job queues 308 can queue one or more jobs associated with the requests 301. The jobs reside in the job queue until they can be scheduled by the task dispatcher 310 to run on one or more pods.

The task dispatcher 310 queues jobs and/or tasks across local queues of one or more clusters, in a serial and/or concurrent manner. In some embodiments, the task dispatcher 310 can be implemented using one or more queues (e.g., a FIFO (First In, First Out)) to which applications can submit jobs or tasks. Work items associated with a given job can be scheduled synchronously (code waits until the work item finishes execution), or asynchronously (code continues executing while the work item runs elsewhere). The task dispatcher 310 is configured to provide notifications when jobs are completed and can manage the one or more job queues 308.

The scheduler 304 uses the information collected by the resource collectors 328 to identify a number of requests and/or a number of pods that each of the nodes 322 can handle. For example, in some embodiments, a user (e.g., system administrator) can set threshold values for one or more types of resources (e.g., memory and/or CPU resources) for each of the nodes 322, and the scheduler 304 can use this information (and possibly historical information) to identify a suitable (e.g., an optimal) number of requests and/or pods for each node. When a given threshold value is reached for one of the nodes 322, the scheduler 304 sends a message to the load balancer 306 to adjust the routing and queuing, as explained in more detail elsewhere herein.

The load balancer 306 maintains information indicating which of the nodes 322 are eligible for routing based on the threshold values. For example, the load balancer 306 can maintain a first list comprising IP addresses of nodes 322 that are eligible for routing incoming requests 301, and a second list of nodes 322 that are ineligible for routing incoming requests 301. Initially, all of the nodes 322 can be placed on the first list, and then the lists can be adjusted based on the threshold values. For example, if the scheduler 304 detects that node 322-1 has reached a threshold value, then the scheduler 304 can send a message to the load balancer 306 that causes the IP address of node 322-1 to be moved from the first list to the second list. When another request is received, the load balancer 306 will exclude node 322-1 from the load balancing algorithm, for example. When the scheduler 304 detects that the resources of node 322-1 have fallen below the threshold value, then the scheduler 304 can send another message to the load balancer 306 so that the IP address of node 322-1 is returned to the first list. If the first list is empty (indicating that none of the nodes 322 is available), then the load balancer 306 can queue the requests in the one or more job queues 308 until one or more of the nodes 322 become available for processing the request.

FIG. 4 illustrates a load balancing process in an illustrative embodiment. It is to be understood that this particular process is only an example, and additional or alternative processes can be carried out in other embodiments. The process in FIG. 4 can be implemented at least in part by the global workload manager 302.

Step 402 includes configuring a load balancer (e.g., an external load balancer) across a plurality of clusters. For example, step 402 can include adding all node IP addresses to a first list (also referred to herein as an active routing bucket).

Step 404 includes configuring (e.g., by scheduler 304) at least one threshold value for each node in a given one of the clusters. In some embodiments, the at least one threshold value can correspond to at least one corresponding resource type (e.g., a threshold value for memory resources and/or a threshold value for CPU resources).

Step 406 includes configuring at least one resource collector at the node level. Optionally, step 406 can also include configuring a data collection interval for the at least one resource collector. Generally, the at least one resource collector collects resource information corresponding to a given node and sends it to the global scheduler.

Step 408 includes applying a default setting to the load balancer, and adding all nodes to an active routing list. For example, the default setting can include a default load balancing algorithm, and each node can be added to the active routing list by adding IP addresses associated with the nodes.

Step 410 includes monitoring data collected by the at least one resource collector.

Step 412 includes a test that checks whether any node exceeds the at least one threshold value. If yes, then the process continues to step 414.

Step 414 includes moving any node that exceeds the corresponding threshold value(s) to an inactive routing list and removing any node that falls below the corresponding threshold value(s) from the inactive routing list. Nodes that are removed from the inactive routing list can be added back to the active routing list. For example, step 414 can include triggering the load balancer to move the IP address of the nodes that exceed the corresponding threshold value(s) to the inactive routing list. A given node is kept on the inactive routing list until the resources of that node drop below the threshold value, in which case the load balancer can be triggered to move the IP address back to the active routing list. If the result of step 412 is no, then the process continues directly to step 416.

Step 416 includes a test that checks whether any nodes remain on the active routing list. If the result of step 416 is yes, then step 418 includes processing incoming requests with the nodes on the active routing list.

If the result of step 416 is not, then the process continues to step 420. Step 420 includes querying incoming requests until a node is added back to the active routing list (e.g., when the resources of one or more nodes fall below the corresponding threshold values). The queued requests can then be processed at step 418.

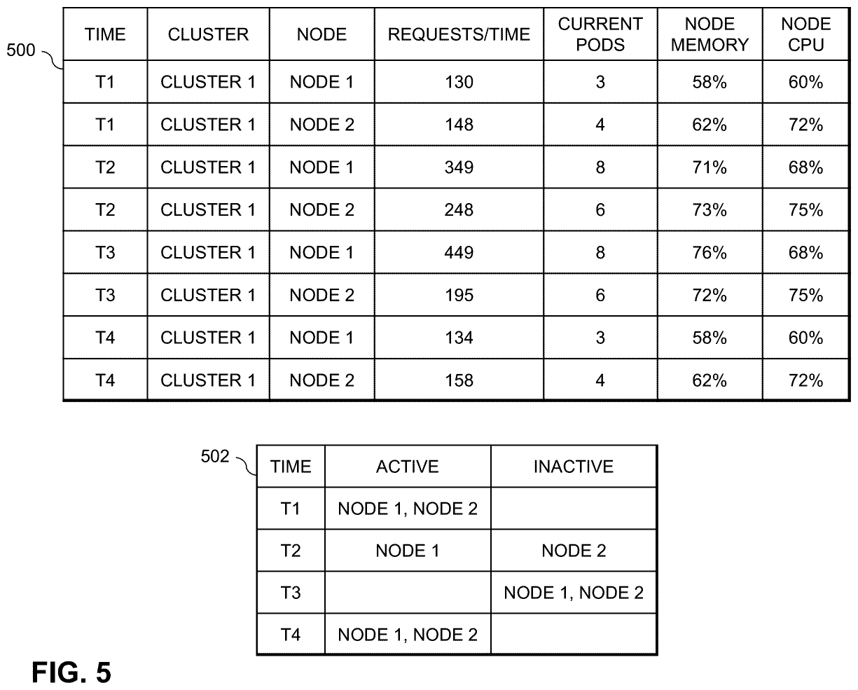

FIG. 5 shows a first table 500 including data collected for a set of nodes of a given cluster and a second table 502 indicating nodes that are available for routing incoming requests in an illustrative embodiment. In the FIG. 5 example, it assumed that data are collected at fixed intervals (e.g., every ten seconds), however, it is to be appreciated that different intervals and/or schedules can be used in other embodiments. For example, a user can configure the interval and/or configure a schedule for collecting such data. It is also assumed that node 1 is configured with a maximum memory threshold of 75%, and node 2 is configured with a maximum memory threshold of 72%. At time T1, the “active” column in table 502 includes nodes 1 and 2 as the threshold values have not been exceeded.

At time T2, table 500 indicates that node 2 has exceeded the maximum memory threshold of 72%, which causes the global scheduler (e.g., scheduler 104) to send a message to the load balancer to move node 2 from the active column to the inactive column at T2.

At T3, table 500 indicates that node 1 also exceeds its maximum memory threshold of 75%. This causes node 1 to be moved to the inactive column in table 502 at T3. As a result, the load balancer will queue any further requests.

At T4, table 500 indicates that nodes 1 and 2 have fallen below their respective maximum memory threshold values, and thus are moved back to the active column in table 502. As a result, the load balancer will start routing requests to both nodes 1 and 2. For example, the load balancer can begin with the requests in the queue using its default load balancing algorithm.

It is to be appreciated that the tables 500 and 502 are merely examples and are not intended to be limiting. For example, it is to be appreciated that table 500 may include different data (e.g., only memory resources) or may include other data and/or metrics (e.g., data related to network resources).

FIG. 6 shows a flow diagram of a load balancing process for container-based architectures in an illustrative embodiment. It is to be understood that this particular process is only an example, and additional or alternative processes can be carried out in other embodiments. In this embodiment, the process includes steps 602 through 608. These steps are assumed to be performed at least in part by a global workload manager 302 utilizing at least portions of its elements 304, 306, 308, and 310.

Step 602 includes obtaining one or more threshold values for each of a plurality of nodes in at least one cluster of a container-based computing environment, wherein the one or more threshold values are configured for one or more corresponding resource types. Step 604 includes obtaining resource consumption data for each of the plurality of nodes. Step 606 includes determining, based at least in part on the one or more obtained threshold values and the obtained resource consumption data, a set of available nodes from among the plurality of nodes for processing incoming requests to the container-based computing environment. Step 608 includes initiating a routing of the incoming requests to one or more nodes in the set of available nodes.

The determining may include: determining that the resource consumption data for a given node in the set of available nodes exceeds at least one of the one or more threshold values configured for the given node; and removing the given node from the set of available nodes in response to said determining. The process may include the following step: adding the given node back to the set of available nodes in response to determining that the resource consumption data for the given node falls below the at least one threshold value for the given node. The process may further include the following step: in response to determining that the set of available nodes is empty, queuing one or more further incoming requests. The process may further include the following step: processing the one or more further incoming requests in response to one of the plurality of nodes being added to the set of available nodes. The resource consumption data may correspond to one or more of: a number of pods currently deployed on a given one of the nodes; a number of incoming requests over a given time interval; and consumption data for one or more types of resources. The resource consumption data for a given node of the plurality of nodes may be obtained from an auxiliary application running on the given node. The determining the set of available nodes may include: maintaining a list comprising a respective identifier for each node in the set of available nodes. The initiating the routing of the incoming requests may include: selecting, by a load balancer that is external to the at least one cluster, the one or more nodes in the set of available nodes using a load balancing algorithm.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve load balancing processes by providing node and/or pod resource consumption information to a load balancer, and routing incoming requests based at least in part on such information. These and other embodiments can effectively overcome problems associated with existing load balancing techniques that can cause node failures, particularly in multi-node and/or multi-cluster environments.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the pod-based container orchestration environment 100 and/or information processing system 200 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the pod-based container orchestration environment 100 and/or information processing system 200. For example, containers can be used to implement respective processing devices providing compute and/or storage services of a cloud-based system. Again, containers may be used in combination with other virtualization infrastructure such as virtual machines implemented using a hypervisor.

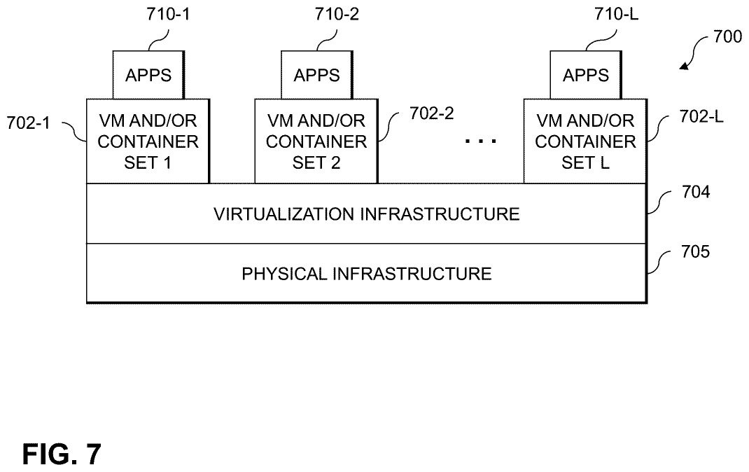

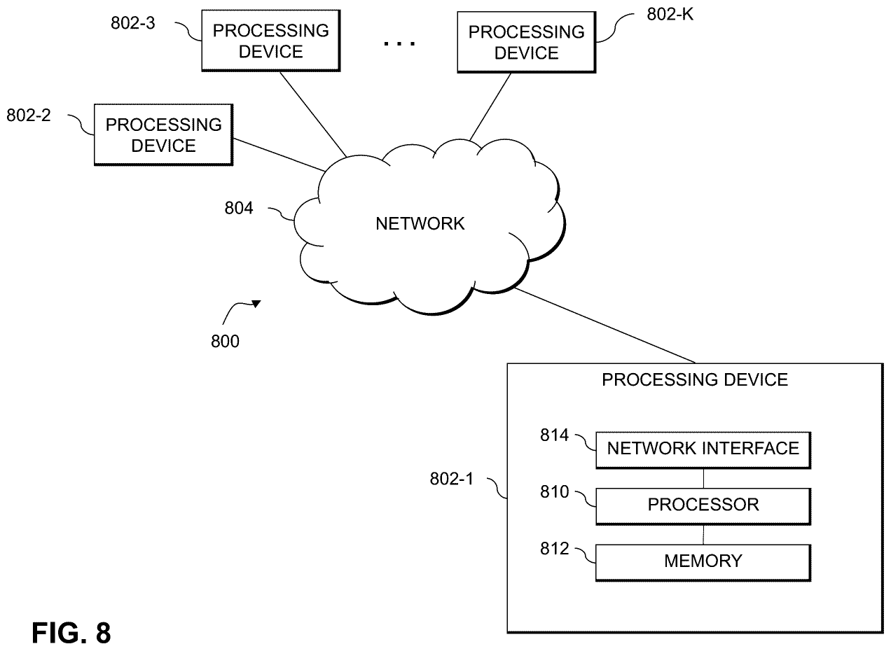

Illustrative embodiments of processing platforms will now be described in greater detail with reference to FIGS. 7 and 8. Although described in the context of pod-based container orchestration environment 100 and/or information processing system 200, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the pod-based container orchestration environment 100 and/or information processing system 200. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of pod-based container orchestration environment 100 and/or information processing system 200 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of pod-based container orchestration environment 100 and/or information processing system 200 and includes a plurality of processing devices, denoted 802-1, 802-2, 802-3, . . . 802-K, which communicate with one another over a network 804.

The processing device 802-1 in the processing platform 800 comprises a processor 810 coupled to a memory 812.

The processor 810 processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and pod-based container orchestration environment 100 and/or information processing system 200 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the pod-based container orchestration environment 100 and/or information processing system 200. Such components can communicate with other elements of the pod-based container orchestration environment 100 and/or information processing system 200 over any type of network or other communication media.

For example, particular types of storage products that can be used in implementing a given storage system of a distributed processing system in an illustrative embodiment include network-attached storage (NAS), storage area networks (SANs), direct-attached storage (DAS) and distributed DAS, as well as combinations of these and other storage types, including software-defined storage.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining one or more threshold values for each of a plurality of nodes in at least one cluster of a container-based computing environment, wherein the one or more threshold values are configured for one or more corresponding resource types;
obtaining resource consumption data for each of the plurality of nodes;
determining, based at least in part on the one or more obtained threshold values and the obtained resource consumption data, a set of available nodes from among the plurality of nodes for processing incoming requests to the container-based computing environment; and
initiating a routing of the incoming requests to one or more nodes in the set of available nodes;
wherein the method is performed by at least one processing device comprising a processor coupled to a memory.

2. The computer-implemented method of claim 1, wherein the determining comprises:
determining that the resource consumption data for a given node in the set of available nodes exceeds at least one of the one or more threshold values for the given node; and
removing the given node from the set of available nodes in response to said determining.

3. The computer-implemented method of claim 2, wherein further comprising:
adding the given node back to the set of available nodes in response to determining that the resource consumption data for the given node falls below the at least one threshold value for the given node.

4. The computer-implemented method of claim 1, further comprising:
in response to determining that the set of available nodes is empty, queuing one or more further incoming requests.

5. The computer-implemented method of claim 4, further comprising:
processing the one or more further incoming requests in response to one of the plurality of nodes being added to the set of available nodes.

6. The computer-implemented method of claim 1, wherein the resource consumption data corresponds to one or more of:
a number of pods currently deployed on a given one of the nodes;
a number of incoming requests over a given time interval; and
consumption data for one or more types of resources.

7. The computer-implemented method of claim 1, wherein the resource consumption data for a given node of the plurality of nodes is obtained from an auxiliary application running on the given node.

8. The computer-implemented method of claim 1, wherein the determining the set of available nodes comprises:
maintaining a list comprising a respective identifier for each node in the set of available nodes.

9. The computer-implemented method of claim 1, wherein the initiating the routing of the incoming requests comprises:
selecting, by a load balancer that is external to the at least one cluster, the one or more nodes in the set of available nodes using a load balancing algorithm.

10. A non-transitory processor-readable storage medium having stored therein program code of one or more software programs, wherein the program code when executed by at least one processing device causes the at least one processing device:
to obtain one or more threshold values for each of a plurality of nodes in at least one cluster of a container-based computing environment, wherein the one or more threshold values are configured for one or more corresponding resource types;
to obtain resource consumption data for each of the plurality of nodes;
to determine, based at least in part on the one or more obtained threshold values and the obtained resource consumption data, a set of available nodes from among the plurality of nodes for processing incoming requests to the container-based computing environment; and
to initiate a routing of the incoming requests to one or more nodes in the set of available nodes.

11. The non-transitory processor-readable storage medium of claim 10, wherein the determining comprises:
determining that the resource consumption data for a given node in the set of available nodes exceeds at least one of the one or more threshold values configured for the given node; and
removing the given node from the set of available nodes in response to said determining.

12. The non-transitory processor-readable storage medium of claim 11, wherein the program code further causes the at least one processing device:
to add the given node back to the set of available nodes in response to determining that the resource consumption data for the given node falls below the at least one threshold value for the given node.

13. The non-transitory processor-readable storage medium of claim 10, wherein the program code causes the at least one processing device further:
in response to determining that the set of available nodes is empty, to queue one or more further incoming requests.

14. The non-transitory processor-readable storage medium of claim 13, wherein the program code causes the at least one processing device further:
to process the one or more further incoming requests in response to one of the plurality of nodes being added to the set of available nodes.

15. The non-transitory processor-readable storage medium of claim 10, wherein the resource consumption data corresponds to one or more of:
a number of pods currently deployed on a given one of the nodes;
a number of incoming requests over a given time interval; and
consumption data for one or more types of resources.

16. An apparatus comprising:
at least one processing device comprising a processor coupled to a memory;
the at least one processing device being configured:
to obtain one or more threshold values for each of a plurality of nodes in at least one cluster of a container-based computing environment, wherein the one or more threshold values are configured for one or more corresponding resource types;
to obtain resource consumption data for each of the plurality of nodes;
to determine, based at least in part on the one or more obtained threshold values and the obtained resource consumption data, a set of available nodes from among the plurality of nodes for processing incoming requests to the container-based computing environment; and
to initiate a routing of the incoming requests to one or more nodes in the set of available nodes.

17. The apparatus of claim 16, wherein the determining comprises:
determining that the resource consumption data for a given node in the set of available nodes exceeds at least one of the one or more threshold values configured for the given node; and
removing the given node from the set of available nodes in response to said determining.

18. The apparatus of claim 17, wherein the at least one processing device is further configured:
to add the given node back to the set of available nodes in response to determining that the resource consumption data for the given node falls below the at least one threshold value for the given node.

19. The apparatus of claim 16, wherein the at least one processing device is further configured:
in response to determining that the set of available nodes is empty, to queue one or more further incoming requests.

20. The apparatus of claim 19, wherein the at least one processing device is further configured:
to process the one or more further incoming requests in response to one of the plurality of nodes being added to the set of available nodes.
